(19) United States
(12) Patent Application Publication
(10) Pub. No.: US 2010/0145720 A1
(43) Pub. Date: Jun. 10, 2010

(54) Method of extracting real-time structured data and performing data analysis and decision support in medical reporting

(76) Inventor: Bruce Reiner, Berlin, MD (US)

Correspondence Address: AKERMAN SENTERFITT, 8100 BOONE BOULEVARD, SUITE 700, VIENNA, VA, 22182-2683, US

(21) Appl. No.: 12/591,979

(22) Filed: Dec. 7, 2009

Related U.S. Application Data
(60) Provisional application No. 61/193,548, filed on Dec. 5, 2008.

(51) Int. Cl. G06Q 50/00; G06Q 10/00; G06N 5/02

(52) U.S. Cl. 705/2; 705/7; 705/11; 705/328; 706/52

(57) ABSTRACT

The present invention relates to a methodology for the conversion of unstructured, free text data (contained within medical reports) into standardized, structured data, and also relates to a decision support feature for use in diagnosis and treatment options.

### CROSS-REFERENCE TO RELATED APPLICATIONS

The present invention claims priority from U.S. Provisional Patent Application No. 61/193,548, filed Dec. 5, 2008, the contents of which are herein incorporated by reference in its entirety.

### BACKGROUND OF THE INVENTION

1. Field of the Invention

The present invention relates to a novel methodology for the conversion of unstructured, free text data (contained within medical reports) into standardized, structured data. This structured data can in turn be entered into medical databases, mapped to a series of medical ontologies, and used for prospective clinical research, outcomes analysis, and the establishment of “best clinical practice’ guidelines. The iterative nature of these analyses provides a mechanism for continuous refinement, research, new technology development, and education/training, based upon reproducible and verifiable clinical data.

In addition, the present invention discloses a decision support feature which assists a user with differential diagnoses and treatment options. In this feature, specific data elements are inputted into the database and a differential medical diagnosis is elicited after analysis, along with probability statistics thereof. Additional data elements which could confirm or deny the diagnosis in question are presented to the clinician.

2. Description of the Related Art

Presently, most medical reports are constructed using free text, in a prose (i.e., sentence/paragraph) format. Report output has remained relatively static over the past century, with different reporting input technologies developed (e.g., digital dictation, speech recognition) to facilitate input. The end result consists of non-standardized report data elements, which prohibit any effective means of report mining. With the impetus to adopt evidence-based medicine (EBM) throughout the practice of medicine, data-driven comparative analysis has become the mainstay of determining optimized clinical practice. While some standardized data elements currently exists in clinical practice (e.g., numerical laboratory values), the vast majority of textual based data elements remain in a non-standardized format. Until a reproducible methodology is developed to convert this existing unstructured free-text data into structured and standardized data, large-scale data mining efforts are effectively undermined.

For example, more specifically, the qualities of an optimum medical report can be characterized by the “6 C's”: 1) clarity, 2) correctness, 3) confidence, 4) concise, 5) completeness, and 6) consistency. These attributes are significantly lacking in the existing reporting paradigm due to the introduction of subjectivity, extreme verbosity, ambiguity and uncertainty, incompleteness of data, and intra/inter-author variability. One can argue that the intrinsic clinical value of medical reporting is often inversely proportional to its length; for excessive verbiage is often used to counteract uncertainty on the part of the authoring physician. At the same time, the subjective nature of the current free-text reporting format can serve as a source of medical error, in the form of differing interpretations of report content. For these reasons alone, it is critical that new reporting strategies are required to standardize and objectify medical report content.

A few relevant examples of how report content can be misinterpreted can be illustrated with excerpts from 3 different mammographic reports, all describing a density within one breast.

1) “A poorly defined density is visualized at the 9 o-clock position of the left breast, which is visualized on a single cranio-caudad projection. It is uncertain whether this finding is artefactual or pathologic in nature, and clinical correlation is recommended.” 2) “The poorly defined density in the left breast previously described on the prior mammographic study is not clearly visualized on the current study, which may be the result of technical differences.”

3) “Further evaluation of the poorly defined left breast density can consist of follow-up mammogram or biopsy, in accordance with the clinical concern for malignancy.”

Based on these three different mammographic reports, one is left with marked variability in the certainty of the finding, determination of the clinical significance, and requisite follow-up. Is this density real or artefactual? Is there another non-invasive imaging study or clinical test that can provide a more definitive answer? To what degree is cancer of concern, (i.e., malignant probability), and would a surgical consultation be in order?

One can see that different readers of the same report could easily come to different conclusions, due to the equivocal nature of report findings. One physician may interpret the possibility of malignancy as warranting immediate biopsy and tissue diagnosis, while another clinician may interpret the lack of reproducibility as indirect evidence of a clinically insignificant finding. The same patient, with the same imaging data, may be told different information, based upon the variability in the interpretation of the free text report data. This underscores both the necessity in standardizing report content and criticality of prospective analysis of report content for objective assessment of diagnostic accuracy.

Once the conclusion is reached that structured and standardized reporting is a necessary requisite for EBM, the next step is to mandate its creation and adopt universal standards for its use. However, the present state of clinical procedures does not go this far. Multi-factorial reasons abound, and impediments to the adoption of structured reporting partly include the psychological, technical, and workflow issues, such as: 1) psychology, 2) technical, 3) workflow, 4) educational, and 5) economic.

From a psychological standpoint, experienced practitioners who have been reporting in the same manner for their entire careers are often reluctant to give up the “tried and true’ method for the “unknown and untested”. While often understated, many physicians have become dependent upon free text to mask their own limitations in diagnostic certainty, and would be forced to become more definitive in a structured reporting environment.

The technical aspects of structured reporting adoption are tied to the information technologies currently used to create, analyze, and display reports. The technologies involved in the above mammographic report creation would include the mammography acquisition device (imaging data), the picture archival and communication system (PACS) used to display the images and create the report, the computer-aided detection software (CAD) used to render a computer-based identification of pathologic findings, the radiology information system (RIS) used to record clinical, historical, and technical data pertinent to the examination performed, and the electronic medical record (EMR) used to display the report and other relevant clinical data. If one was to attempt to cross-reference data from these different information technologies (i.e., correlate the mammography repot findings (PACS) with the pathology report finding (EMR)), the current process would be largely manual in nature and limited by the non-standardized nature of the data being evaluated.

Current technology for report creation (residing on the PACS) is extremely awkward and consists of pull-down menus incorporating structured data elements tied to a standardized lexicon. In order for physicians to create the structured report using this technology, they would be forced to manually select from pull-down menus; which limits content selection and retards workflow. Widespread acceptance will therefore require alternative technology development which is both workflow-enabling and non-restrictive of content input.

The two additional factors prohibiting acceptance for structured reporting are educational and economic. Simply stated, experienced users are reluctant to be forced to learn a new lexicon when they perceive the conventional lexicon as sufficient. At the same time, if there is no financial incentive in adopting the new system than the interest level among the end-users will be limited.

Thus, a new methodology for the conversion of unstructured, free text data into standardized, structured data, is needed. A new methodology offers the potential to transcend the subjective manner in which medical reporting is currently practiced, into data-driven objective reporting, which can be prospectively analyzed (in real-time) and used to actively promote EBM.

Further, a new methodology for decision support which is useful for differential diagnosis in a decision support application, and which can provide a statistical probability of each diagnosis, along with data elements which confirm or deny the diagnosis, is desired.

### SUMMARY OF THE INVENTION

The present invention relates to a methodology for the conversion of unstructured, free text data (contained within medical reports) into standardized, structured data. The present invention also relates to a decision support feature for use in diagnosis and treatment options.

In a first embodiment consistent with the present invention, a computer-implemented method of identifying and extracting predetermined conceptual information from a free text report, includes: extracting data elements from the free text report; performing a statistical analysis of said data elements to identify the predetermined conceptual information and locate synonymous nomenclature; mapping said synonymous nomenclature to a standardized lexicon such that a single set of structured data elements is recorded as report data in a report database; and performing clinical validation of said nomenclature mapping step to verify said standardized lexicon.

In another embodiment consistent with the present invention, the data elements include technical data, historical data, clinical data, and imaging data.

In yet another embodiment consistent with the present invention, outcomes analysis of the report data is performed.

In yet another embodiment consistent with the present invention, a profile for a clinician that defines context-specific data requirements for said clinician, is established.

In yet another embodiment consistent with the present invention, trending analysis to provide statistical data outlining performance metrics and best practice guidelines is performed.

In yet another embodiment consistent with the present invention, the report is automatically edited.

In yet another embodiment consistent with the present invention, a prospective structured data analysis is performed.

In yet another embodiment, the present invention includes providing data specific to said structured data elements; and presenting educational content specific to said structured data elements.

In a second embodiment consistent with the present invention, a computer-implemented method of providing data analysis and decision support in a medical application includes: activating an automated differential diagnosis function; inputting specific data elements derived from multiple informational data sources; creating a list of differential diagnoses based upon said inputted data elements; providing a statistical probability for each said list of differential diagnoses in rank order; specifying a degree in which said inputted data elements contribute to or ignore said list of differential diagnoses; providing another list of data elements which could confirm or deny said differential diagnoses; and determining a medical diagnosis and a relative risk thereof.

In yet another embodiment, the present invention includes providing information on a specific diagnosis, and supporting or conflicting data thereon.

In yet another embodiment, the present invention includes inputting patient-specific genetic data to determine a probability of disease occurrence.

In yet another embodiment, the invention includes retrieving data from a database to identify which data is available for analysis and which data is not available for analysis, after said inputting step.

In yet another embodiment, the invention includes determining association relationships between disparate data elements specific to said medical diagnosis.

In yet another embodiment consistent with the present invention, a computer-implemented method of providing data analysis and decision support in a medical application includes: activating an automated differential diagnosis function; inputting a specific medical diagnosis; determining specific data elements derived from multiple informational data sources related to said medical diagnosis; specifying a degree in which said data elements contribute to or ignore said medical diagnosis; and determining whether said data elements confirm or deny said medical diagnosis.

In yet another embodiment, an analysis of said database is used to create a user-specific decision support profile for at least an education/training program.

In yet another embodiment, a computer-implemented method of providing data analysis and decision support in a medical application includes: providing medical data on a patient from a database to a clinician for review; identifying specific data related to said patient and retrieving current and prior data from said database; providing a statistical probability of relative importance of each data; receiving a list of differential diagnoses; performing an automated differential diagnosis function; and deriving a weighted differential diagnosis and providing specific data which contributed to said weighted differential diagnosis;

In yet another embodiment, the invention includes selecting an individual diagnosis and providing diagnosis and/or treatment planning options.

In yet another embodiment, the invention includes obtaining a statistical analysis to identify comparative data between different diagnosis and/or treatment planning options.

In yet another embodiment, the invention includes providing comparative complication rates in a defined geographic area to said clinician.

In yet another embodiment, the invention includes cross-referencing the patient's insurance data with provider data to determine a provider with a lowest complication rate.

In yet another embodiment, the invention includes generating recommendations for disease prevention, diagnosis and/or treatment in accordance with patient and provider specific data.

In yet another embodiment, the invention includes providing disease-specific data into said database and locating patients with similar data elements and defined diagnoses.

In yet another embodiment consistent with the present invention, inputting tests and/or procedures into said database to derive a statistical likelihood of iatrogenic complications or adverse reactions, is provided.

In yet another embodiment, the invention includes inputting diagnosis and procedural data into said database to determine clinical outcomes.

In yet another embodiment, the invention includes performing a cross-correlation of data to derive disease-specific best practice guidelines.

In yet another embodiment, the invention includes creating technology and provider-specific clinical outcomes statistics from specific diagnoses and patient profiles.

In yet another embodiment, the invention includes utilizing multi-institutional databases to create patient, institutional, and technology-specific profiles.

In yet another embodiment, the invention includes highlighting certain of said structured data elements contained within report data; providing data specific to said structured data elements; and providing educational content specific to said highlighted structured data elements.

In yet another embodiment consistent with the present invention, a computer-implemented method of providing an education and training feature in a medical application includes: activating an education option for a user; displaying a selected option from one of diagnosis, prevention or treatment; providing the user with a training option; providing a case study to the user; providing the user with an option for obtaining additional data, or testing with a cost/benefit analysis thereof; providing feedback to the user as to which data is supportive or which data is contradictory along with relative weighting of said data; and providing analyses to the user along with derived data and comparative data of peers.

In yet another embodiment, the invention includes recording said data for future review and analyses.

Thus has been outlined, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

FIG. 1 is a schematic drawing of the major components of a methodology for the conversion of unstructured, free text data (contained within medical reports) into standardized, structured data, according to one embodiment consistent with the present invention, and to carry out a decision support feature with respect to diagnosis and treatment in a medical application, according to a second embodiment consistent with the present invention.

FIGS. 2A and 2B are exemplary flow charts of a method of identifying and extracting important concepts from a free text report.

FIG. 3 is an exemplary flow chart showing an automatic editing function of the invention of FIGS. 2A and 2B.

FIG. 4 is an exemplary flow chart showing a prospective structured data analysis of the invention of FIGS. 2A and 2B.

FIG. 5 is an exemplary flow chart showing a decision support feature according to another embodiment consistent with the present invention.

FIG. 6 is an exemplary flow chart showing a decision support feature for differential diagnosis, according to the embodiment of FIG. 5.

FIG. 7 is an exemplary flow chart of an educational/training feature of the present invention.

### DESCRIPTION OF THE INVENTION

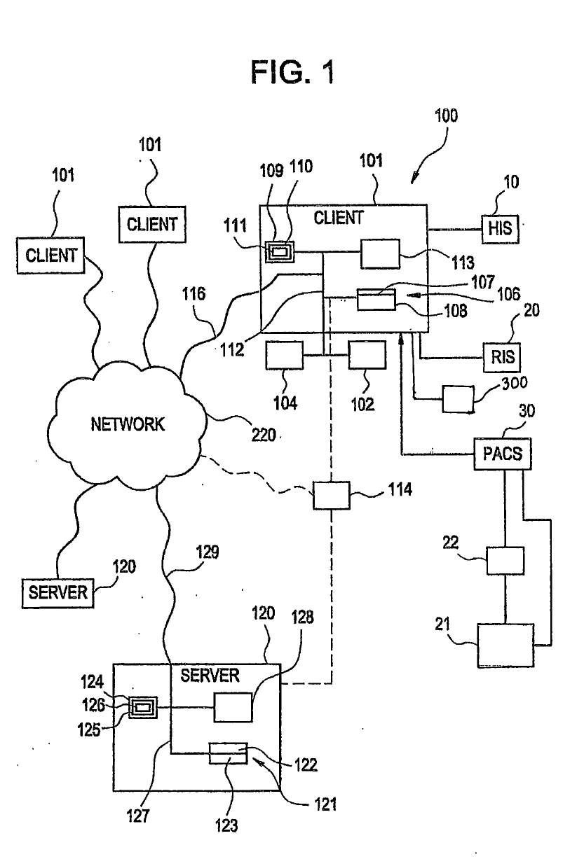

According to one embodiment of the invention, as illustrated in FIG. 1, the major components of a methodology for the conversion of unstructured, free text data (contained within medical reports) into standardized, structured data, in medical (i.e., radiological) applications may be implemented using the system 100. The system 100 is designed to interface with existing information systems such as a Hospital Information System (HIS) 10, a Radiology Information System (RIS) 20, a radiographic device 21, and/or other information systems that may access a computed radiography (CR) cassette or direct radiography (DR) system, a CR/DR plate reader 22, a Picture Archiving and Communication System (PACS) 30, perhaps an eye movement detection apparatus 300, the electronic medical record (EMR), computer-aided detection (CAD), and/or other systems. The system 100 may be designed to conform with the relevant standards, such as the Digital Imaging and Communications in Medicine (DICOM) standard, DICOM Structured Reporting (SR) standard, and/or the Radiological Society of North America's Integrating the Healthcare Enterprise (IHE) initiative, among other standards.

According to one embodiment, bi-directional communication between the system 100 of the present invention and the information systems, such as the HIS 10, RIS 20, radiographic device 21, CR/DR plate reader 22, PACS 30, and eye movement detection apparatus 300, etc., may be enabled to allow the system 100 to retrieve and/or provide information from/to these systems. According to one embodiment of the invention, bi-directional communication between the system 100 of the present invention and the information systems allows the system 100 to update information that is stored on the information systems. According to one embodiment of the invention, bi-directional communication between the system 100 of the present invention and the information systems allows the system 100 to generate desired reports and/or other information.

The system 100 of the present invention includes a client computer 101, such as a personal computer (PC), which may or may not be interfaced or integrated with the PACS 30. The client computer 101 may include an imaging display device 102 that is capable of providing high resolution digital images in 2-D or 3-D, for example. According to one embodiment of the invention, the client computer 101 may be a mobile terminal if the image resolution is sufficiently high. Mobile terminals may include mobile computing devices, a mobile data organizer (PDA), or other mobile terminals that are operated by the user accessing the program 110 remotely. According to another embodiment of the invention, the client computers 101 may include several components, including processors, RAM, a USB interface, a telephone interface, microphones, speakers, a computer mouse, a wide area network interface, local area network interfaces, hard disk drives, wireless communication interfaces, DVD/CD readers/burners, a keyboard, and/or other components. According to yet another embodiment of the invention, client computers 101 may include, or be modified to include, software that may operate to provide data gathering and data exchange functionality.

According to one embodiment of the invention, an input device 104 or other selection device, may be provided to select hot clickable icons, selection buttons, and/or other selectors that may be displayed in a user interface using a menu, a dialog box, a roll-down window, or other user interface. In addition or substitution thereof, the input device may also be an eye movement detection apparatus 300, which detects eye movement and translates those movements into commands.

The user interface may be displayed on the client computer 101. According to one embodiment of the invention, users may input commands to a user interface through a programmable stylus, keyboard, mouse, speech processing device, laser pointer, touch screen, or other input device 104, as well as an eye movement detection apparatus 300.

According to one embodiment of the invention, the client computer system 101 may include an input or other selection device 104, 300 which may be implemented by a dedicated piece of hardware or its functions may be executed by code instructions that are executed on the client processor 106. For example, the input or other selection device 104, 300 may be implemented using the imaging display device 102 to display the selection window with an input device 104, 300 for entering a selection.

According to another embodiment of the invention, symbols and/or icons may be entered and/or selected using an input device 104 such as a multi-functional programmable stylus 104. The multi-functional programmable stylus may be used to draw symbols onto the image and may be used to accomplish other tasks that are intrinsic to the image display, navigation, interpretation, and reporting processes, as described in U.S. patent application Ser. No. 11/512,199 filed on Aug. 30, 2006, the entire contents of which are hereby incorporated by reference. The multi-functional programmable stylus may provide superior functionality compared to traditional computer keyboard or mouse input devices. According to one embodiment of the invention, the multi-functional programmable stylus also may provide superior functionality within the PACS 30 and Electronic Medical Report (EMR).

In one embodiment consistent with the present invention, the eye movement detection apparatus 300 that is used as an input device 104, may be similar to the Eye-Tracker SU4000 (made by Applied Science Laboratories, Bedford, Mass.) with head-tracking capability. However, other types of eye tracking devices may be used, as long they are able to compute line of gaze and dwell time with sufficient accuracy.

According to one embodiment of the invention, the client computer 101 may include a processor 106 that provides client data processing. According to one embodiment of the invention, the processor 106 may include a central processing unit (CPU) 107, a parallel processor, an input/output (I/O) interface 108, a memory 109 with a program 110 having a data structure 111, and/or other components. According to one embodiment of the invention, the components all may be connected by a bus 112. Further, the client computer 101 may include the input device 104, 300, the image display device 102, and one or more secondary storage devices 113. According to one embodiment of the invention, the bus 112 may be internal to the client computer 101 and may include an adapter that enables interfacing with a keyboard or other input device 104. Alternatively, the bus 112 may be located external to the client computer 101.

According to one embodiment of the invention, the client computer 101 may include an image display device 102 which may be a high resolution touch screen computer monitor. According to one embodiment of the invention, the image display device 102 may clearly; easily and accurately display images, such as x-rays, and/or other images. Alternatively, the image display device 102 may be implemented using other touch sensitive devices including tablet personal computers, pocket personal computers, plasma screens, among other touch sensitive devices. The touch sensitive devices may include a pressure sensitive screen that is responsive to input from the input device 104, such as a stylus, that may be used to write/draw directly onto the image display device 102.

According to another embodiment of the invention, high resolution goggles may be used as a graphical display to provide end users with the ability to review images. According to another embodiment of the invention, the high resolution goggles may provide graphical display without imposing physical constraints of an external computer.

According to another embodiment, the invention may be implemented by an application that resides on the client computer 101, wherein the client application may be written to run on existing computer operating systems. Users may interact with the application through a graphical user interface. The client application may be ported to other personal computer (PC) software, personal digital assistants (PDAs), cell phones, and/or any other digital device that includes a graphical user interface and appropriate storage capability.

According to one embodiment of the invention, the processor 106 may be internal or external to the client computer 101. According to one embodiment of the invention, the processor 106 may execute a program 110 that is configured to perform predetermined operations. According to one embodiment of the invention, the processor 106 may access the memory 109 in which may be stored at least one sequence of code instructions that may include the program 110 and the data structure 111 for performing predetermined operations. The memory 109 and the program 110 may be located within the client computer 101 or external thereto.

While the system of the present invention may be described as performing certain functions, one of ordinary skill in the art will readily understand that the program 110 may perform the function rather than the entity of the system itself.

According to one embodiment of the invention, the program 110 that runs the system 100 may include separate programs 110 having code that performs desired operations. According to one embodiment of the invention, the program 110 that runs the system 100 may include a plurality of modules that perform sub-operations of an operation, or may be part of a single module of a larger program 110 that provides the operation.

According to one embodiment of the invention, the processor 106 may be adapted to access and/or execute a plurality of programs 110 that correspond to a plurality of operations. Operations rendered by the program 110 may include, for example, supporting the user interface, providing communication capabilities, performing data mining functions, performing e-mail operations, and/or performing other operations.

According to one embodiment of the invention, the data structure 111 may include a plurality of entries. According to one embodiment of the invention, each entry may include at least a first storage area, or header, that stores the databases or libraries of the image files, for example.

According to one embodiment of the invention, the storage device 113 may store at least one data file, such as image files, text files, data files, audio files, video files, among other file types. According to one embodiment of the invention, the data storage device 113 may include a database, such as a centralized database and/or a distributed database that are connected via a network. According to one embodiment of the invention, the databases may be computer searchable databases. According to one embodiment of the invention, the databases may be relational databases. The data storage device 113 may be coupled to the server 120 and/or the client computer 101, either directly or indirectly through a communication network, such as a LAN, WAN, and/or other networks. The data storage device 113 may be an internal storage device. According to one embodiment of the invention, the system 100 may include an external storage device 114. According to one embodiment of the invention, data may be received via a network and directly processed.

According to one embodiment of the invention, the client computer 101 may be coupled to other client computers 101 or servers 120. According to one embodiment of the invention, the client computer 101 may access administration systems, billing systems and/or other systems, via a communication link 116. According to one embodiment of the invention, the communication link 116 may include a wired and/or wireless communication link, a switched circuit communication link, or may include a network of data processing devices such as a LAN, WAN, the Internet, or combinations thereof. According to one embodiment of the invention, the communication link 116 may couple e-mail systems, fax systems, telephone systems, wireless communications systems such as pagers and cell phones, wireless PDA's and other communication systems.

According to one embodiment of the invention, the communication link 116 may be an adapter unit that is capable of executing various communication protocols in order to establish and maintain communication with the server 120, for example. According to one embodiment of the invention, the communication link 116 may be implemented using a specialized piece of hardware or may be implemented using a general CPU that executes instructions from program 110. According to one embodiment of the invention, the communication link 116 may be at least partially included in the processor 106 that executes instructions from program 110.

According to one embodiment of the invention, if the server 120 is provided in a centralized environment, the server 120 may include a processor 121 having a CPU 122 or parallel processor, which may be a server data processing device and an I/O interface 123. Alternatively, a distributed CPU 122 may be provided that includes a plurality of individual processors 121, which may be located on one or more machines. According to one embodiment of the invention, the processor 121 may be a general data processing unit and may include a data processing unit with large resources (i.e., high processing capabilities and a large memory for storing large amounts of data).

According to one embodiment of the invention, the server 120 also may include a memory 124 having a program 125 that includes a data structure 126, wherein the memory 124 and the associated components all may be connected through bus 127. If the server 120 is implemented by a distributed system, the bus 127 or similar connection line may be implemented using external connections. The server processor 121 may have access to a storage device 128 for storing preferably large numbers of programs 110 for providing various operations to the users.

According to one embodiment of the invention, the data structure 126 may include a plurality of entries, wherein the entries include at least a first storage area that stores image files. Alternatively, the data structure 126 may include entries that are associated with other stored information as one of ordinary skill in the art would appreciate.

According to one embodiment of the invention, the server 120 may include a single unit or may include a distributed system having a plurality of servers 120 or data processing units. The server(s) 120 may be shared by multiple users in direct or indirect connection to each other. The server(s) 120 may be coupled to a communication link 129 that is preferably adapted to communicate with a plurality of client computers 101.

According to one embodiment, the present invention may be implemented using software applications that reside in a client and/or server environment. According to another embodiment, the present invention may be implemented using software applications that reside in a distributed system over a computerized network and across a number of client computer systems. Thus, in the present invention, a particular operation may be performed either at the client computer 101, the server 120, or both.

According to one embodiment of the invention, in a client-server environment, at least one client and at least one server are each coupled to a network 220, such as a Local Area Network (LAN), Wide Area Network (WAN), and/or the Internet, over a communication link 116, 129. Further, even though the systems corresponding to the HIS 10, the RIS 20, the radiographic device 21, the CR/DR reader 22, the PACS 30 (if separate), and the eye movement detection apparatus 30, are shown as directly coupled to the client computer 101, it is known that these systems may be indirectly coupled to the client over a LAN, WAN, the Internet, and/or other network via communication links. Further, even though the eye movement detection apparatus 300 is shown as being accessed via a LAN, WAN, or the Internet or other network via wireless communication links, it is known that the eye movement detection apparatus 300 could be directly coupled using wires, to the PACS 30, RIS 20, radiographic device 21, or HIS 10, etc.

According to one embodiment of the invention, users may access the various information sources through secure and/or non-secure internet connectivity. Thus, operations consistent with the present invention may be carried out at the client computer 101, at the server 120, or both. The server 120, if used, may be accessible by the client computer 101 over the Internet, for example, using a browser application or other interface.

According to one embodiment of the invention, the client computer 101 may enable communications via a wireless service connection. The server 120 may include communications with network/security features, via a wireless server, which connects to, for example, voice recognition or eye movement detection. According to one embodiment, user interfaces may be provided that support several interfaces including display screens, voice recognition systems, speakers, microphones, input buttons, eye movement detection apparatuses, and/or other interfaces. According to one embodiment of the invention, select functions may be implemented through the client computer 101 by positioning the input device 104 over selected icons. According to another embodiment of the invention, select functions may be implemented through the client computer 101 using a voice recognition system or eye movement detection apparatus 300 to enable hands-free operation. One of ordinary skill in the art will recognize that other user interfaces may be provided.

According to another embodiment of the invention, the client computer 101 may be a basic system and the server 120 may include all of the components that are necessary to support the software platform. Further, the present client-server system may be arranged such that the client computer 101 may operate independently of the server 120. but the server 120 may be optionally connected. In the former situation, additional modules may be connected to the client computer 101. In another embodiment consistent with the present invention, the client computer 101 and server 120 may be disposed in one system, rather being separated into two systems.

Although the above physical architecture has been described as client-side or server-side components, one of ordinary skill in the art will appreciate that the components of the physical architecture may be located in either client or server, or in a distributed environment.

Further, although the above-described features and processing operations may be realized by dedicated hardware, or may be realized as programs having code instructions that are executed on data processing units, it is further possible that parts of the above sequence of operations may be carried out in hardware, whereas other of the above processing operations may be carried out using software.

The underlying technology allows for replication to various other sites. Each new site may maintain communication with its neighbors so that in the event of a catastrophic failure, one or more servers 120 may continue to keep the applications running, and allow the system to load-balance the application geographically as required.

Further, although aspects of one implementation of the invention are described as being stored in memory, one of ordinary skill in the art will appreciate that all or part of the invention may be stored on or read from other computer-readable media, such as secondary storage devices, like hard disks, floppy disks, CD-ROM, a carrier wave received from a network such as the Internet, or other forms of ROM or RAM either currently known or later developed. Further, although specific components of the system have been described, one skilled in the art will appreciate that the system suitable for use with the methods and systems of the present invention may contain additional or different components.

In a first embodiment, the present invention creates automated technology to provide end-users with the ability to maintain their existing workflow and content (i.e., consistency in data input), while transforming this input data into structured data output, with the ability of the authoring physician to maintain control and autonomy over the final report output. The present invention also has the additional benefits of ensuring that the output data is standardized, mapped to a context-specific ontology, and in a structured format to allow for prospective data mining and cross-referencing with alternative databases for outcomes analysis.

The present invention utilizes natural language processing (NLP) software in a novel program 110, which has the ability to identify and extract important concepts from a free text report, (which can be created in its customary manner). The various concepts extracted by the program 110 are directly mapped to a context-specific ontology. In a mammography report, for example, the various concepts contained within the mammography ontology can be derived by the program 110 using a lexicon (e.g., BIRADS, RadLex) and an automated search of a multi-institutional mammography database 113, 114. This search would be used to identify the following data elements, which are contained within the mammography report:

1) technical data (e.g., acquisition parameters, number and type of views, image processing).

2) historical data (e.g., past medical history, family history, prior surgery/interventional procedures).

3) clinical data (e.g., physical exam findings, laboratory data, clinical testing, genomic data).

4) imaging data (e.g., breast density, pathologic findings, prior imaging data).

Once these report data elements are characterized by the program 110 according to their individual data categories, statistical analysis is performed by the program 110 to identify the various concepts being described and synonymous nomenclature. The synonymous terms are in turn mapped by the program 110 to a standardized lexicon, so that a single set of structured data elements will be recorded into the report database 113, 114 and used for future data mining. Clinical validation of this data mapping would become an essential part of the verification process and ontology creation, to ensure that the structured data elements are comprehensive and consistent with the intention of the authoring physician.

Once the ontology and lexicon have been established, a hierarchy of structured textual data can be established by the program 110, so that the report data can be effectively characterized by the program 110 according to the subject matter and the context with which it is assigned. As an example, pathologic findings contained within a mammogram report (under the category of imaging data) would consist of the pathologic concept itself (e.g., mass), followed by a series of modifying and descriptive data used in conjunction with that particular concept. Descriptive data elements would include (but are not limited to) mass characteristics such as size, density, and morphology. Modifier data elements would include (but are not limited to) temporal change, clinical significance, follow-up recommendations, and anatomic location.

Once the lexicon, ontology, and synonymous terms have been established by the program 110, the program 110 can extract and characterize free-text report data in an automated fashion. These extracted data elements are then mapped by the program 110 to the structured data elements contained within the ontology and presented to the authoring physician for verification, on the display 102. This “verification process” ensures that the intention of the authoring physician (in terms of content and meaning) is indeed accurate, and the process of mapping the terminology used in the report with the standardized nomenclature within the lexicon/ontology is consistent. If the authoring physician determines that the data extraction, characterization, and/or mapping are erroneous, he/she is presented with a number of alternative options:

1) modify the free text (unstructured) data used within the report.

2) select from a list of related structured data elements (which are contained within the lexicon/ontology).

3) request an automated query of the report database 113, 114 to identify similar terms used in other free text reports (context-specific) and associated structured data elements.

This “verification” process has a number of theoretical advantages for both the end-user and the program's 110 search engine. From the end-user's perspective, it creates a valuable educational tool to reinforce to the end-user those “acceptable” structured data elements contained within the lexicon/ontology. Through continuous feedback, the end-user will begin to become better acquainted with the structured data elements and begin to use these in lieu of the non-standardized terms he/she has been traditionally using in report creation. The advantage to the NLP search engine of the program 110 is that the verification process becomes iterative in nature, and effectively “teaches” the program 110 what terms are synonymous with the structured data elements contained within the ontology/lexcion and the number of alternative word usages and meanings (i.e., inferences). By utilizing this “verification” process, the program 110 can also create a context and user-specific profile for each authoring physician, which creates a statistical model as to how different end-users communicate, which data elements are (or are not) included in the report, and how the report data from one authoring physician correlates with other end-users (for similar tasks).

When the report data is in turn cross-referenced by the program 110 with other clinical structured databases 113, 114 to perform outcomes analysis, these author-specific profiles can help identify specific deficiencies, for remedial education and training. As an example, data mining for mammography reports by the program 110 may identify that one particular radiologist has a high diagnostic accuracy for the finding of “mass” with speculated margins and size less than 3 cm. However, that same radiologist has an unexpectedly lower diagnostic accuracy for the finding of “mass” with smooth margins and size less than 3 cm. This data can be presented by the program 110 to the radiologist along with educational programs, specifically designed for “characterization of smoothly marginated breast masses using mammography”. By the program 110 cross-referencing mammography imaging, report, and pathology databases 113, 114 (which can be multi-institutional in nature), a large number of comparable cases can be identified, retrieved, and analyzed by the program 110, for educational purposes.

In the following example, the “education” function of the program 110 can be activated and a search can be performed by the program 110 using the following structured data elements:

1) mammography

2) mass

3) margins, Smooth

4) size: <3 cm

The search parameters can then be defined (departmental, institutional, multi-institutional, regional, national) by the program 110, and even stratified by the program 110, according to a number of context-specific variables (i.e., technology used, patient profile, institutional demographics, pathology correlation). Once the input data has been completed, the databases 113, 114 are queried by the program 110, and a number of cases meeting the search criteria are presented by the program 110 to the end-user on the display 102. The physician can then elect to review any or all of the selected cases, in an attempt to refine his/her diagnostic skills for that specific set of structured data elements.

Once the “verification process” has been completed, the defined structured data elements are used by the program 110 to create a customizable structured report. The report presentation format of this structured data can be created by the program 110 in a prescribed manner dictated by the authoring and/or referring physician. Since the structured data elements within this report are “fixed”, the style in which the report is constructed becomes incidental. A single structured mammography report can therefore, be fashioned in different presentation formats by the program 110, for the internist, surgeon, radiologist, or pathologist reviewing it. This “customization” feature of the structured report can extend beyond presentation state and also include report content.

To illustrate how report content can be customized (in accordance with the end-user profile), an example of a representative structured mammography report describing three (3) pathologic findings is as follows:

1) skin thickening

2) architectural distortion

3) calcifications

In this example, the report is being sent by the program 110 (as directed by the order) to three different physicians: 1) the primary care physician, 2) the surgeon who recently performed a lumpectomy, and 3) a radiation oncologist who performed radiation therapy. The findings of skin thickening and architectural distortion were identified as stable (i.e., no temporal change) and secondary to combined surgery and radiation surgery. The calcifications were identified as new, of uncertain clinical significance, and with the recommendation for follow-up mammogram in four (4) months. The end-user profile of the surgeon, specifically requests that all calcifications on mammography reports have associated descriptors for morphology, number, and distribution. The end-user profile for the radiation oncologist requests all calcifications on mammography have modifiers for anatomic location, clinical significance, and follow-up recommendations. The end-user profile for the primary care physician requests that all findings on mammography have accompanying modifiers for clinical significance and follow-up recommendations.

Based upon these individual physician report profiles, the radiologist creating the mammogram report is presented by the program 110 with an automated prompt that alerts him to the required structured data elements for each of the ordering clinicians. All requested data for the primary care physician has already been included by the program 110 in the entered structured report data; however, some of the requested data elements for the surgeon and radiation oncologist is lacking (i.e., calcification descriptors). When presented with the automated prompt by the program 110, and request for this additional data, the radiologist has the following options:

1) deny additional data entry (which will be recorded and transmitted to the ordering clinicians).

2) add the requested additional data elements only to those specific reports requesting it.

3) add the requested additional data elements to all reports.

If the radiologist selects the second option (i.e., selective data integration), then the additional data requested will be selectively added by the program 110 to the reports, in accordance with the physician report profiles. In this case the following structured data is added to the mammography reports by the program 110:

1) primary physician report: no additional data

2) surgeon: additional data:
a) morphology: pleomorphic
b) number: >10
c) distribution: multi-focal

3) radiation oncologist: additional data:
a) anatomic location: 9 o'clock right breast

The structured data which is recorded into the master report database 113, 114 by the program 110 contains all structured data, whereas the individual reports contain the original structured data, along with the additional requested data in keeping with the profiles of the ordering physicians. In this manner, the structured reports issued to the individual physicians are customized both in presentation format (style) and content.

The automated prompt presented by the program 110 to the authoring radiologist, can also alert the radiologist to other data requirements, separate from the ordering physician profile. The authoring radiologist would also have a profile, which is context-specific. This radiologist profile may be established in several different ways:

1) The individual radiologist defines his/her context-specific data requirements.

2) The radiology department chief may mandate certain context-specific data requirements (above and beyond those within the individual radiologist profile).

3) The institution may mandate certain context-specific data requirements.

4) The payer may request certain context-specific data requirements.

5) The database analysis software may request certain context-specific data requirements.

As an example, a radiology department chief may determine that the pathologic finding of “mass” must have modifiers for clinical significance and follow-up recommendations. The institution may mandate that all mammographic findings have modifiers for temporal change (indicating interval change on sequential exams). The third party payer may request that all mammographic findings of “mass” have recommended ultrasound correlation, prior to performance of a biopsy. In order to perform clinical outcomes analysis, the program 110 may mandate that all imaging findings on mammography have accompanying modifiers for clinical significance and degree of certainty. Governmental regulatory agencies (e.g. Mammography Quality Assurance Act (MQSA)) may mandate that all mammograms have quality assurance (QA) modifiers attached to each report, providing an image quality score.

These examples illustrate how individual and collective parties can introduce report data requirements, for a variety of purposes, all of which can ultimately be factored into the comprehensive analysis of report data and clinical outcomes by the program 110. The essential factor in all examples is that the data being collected and analyzed by the program 110 is structured data, which is directly mapped to an ontology, which in turn can be co-mingled with comparable data from external databases 114 for clinical outcomes analysis. This comprehensive data analysis can be performed by the program 110 between comparable databases 113, 114 (e.g., mammography report databases 114 from multiple institutions) or disparate databases (e.g., breast imaging, clinical, and pathology databases 113, 114 from a single institution).

Once these structured databases 113, 114 are combined and analyzed (meta-analysis) by the program 110, individual trends can be identified by the program 110 which provide statistical data outlining performance metrics (e.g., diagnostic accuracy for screening mammography) and EBM derived “best practice” guidelines (e.g., treatment options for ductal carcinoma in situ (DCIS) in pre-menopausal females with genetic markers for breast cancer).

While the described applications are focused on breast imaging (mammography), the same principles can be applied to all medical disciplines. The common denominators are data extraction using computer-based artificial intelligence (e.g., NLP), creation of context-specific ontologies and standardized lexicons, mapping of the extracted “non-structured” data into “structured” data following a computer-derived rule set (e.g., neural networks), verification of all extracted and mapped data, customization of the structured data report (in accordance with individual user, institutional, and context-specific profiles), and statistical analysis of the structured databases to provide educational feedback, clinical outcomes analysis, and the creation of EBM “best practice” guidelines.

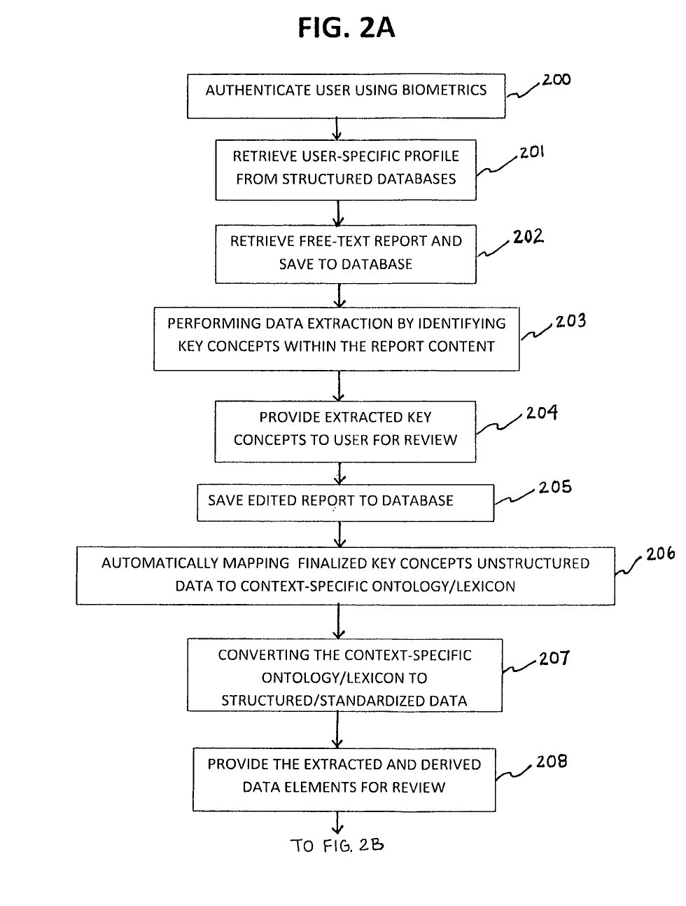

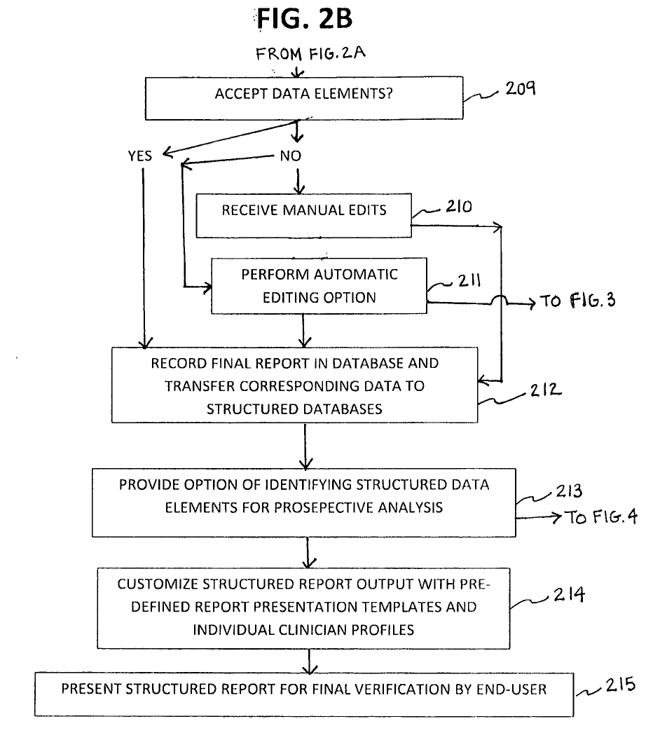

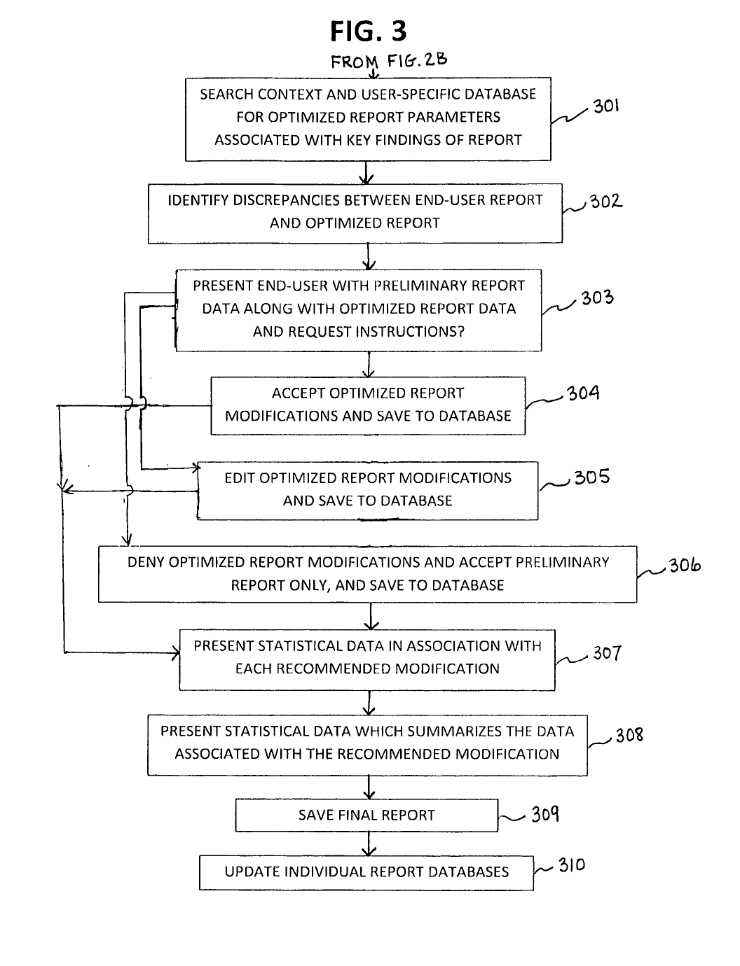

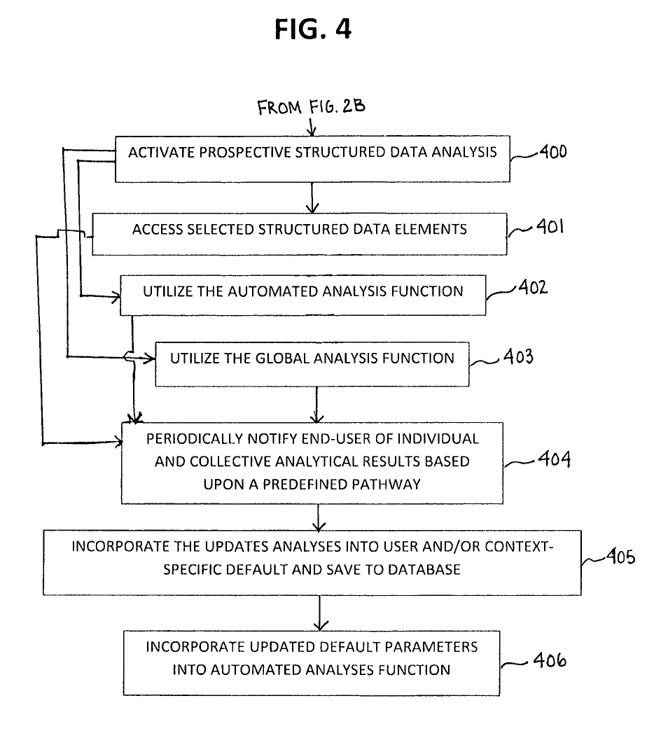

FIGS. 2A and 2B are flow charts which illustrate the operation of the first embodiment of the present invention and the various options available to the end-user.

In FIG. 2A, step 200, the end-user signs on to the client computer 101 using biometrics, as identified in copending U.S. Pat. No. 7,593,549, issued Sep. 22, 2009, the contents of which are herein incorporated by reference in their entirety.

In step 201, the user-specific profile is retrieved by the program 110, from the structure databases 113, 114.

In step 202, the program 110 receives a free-text (unstructured) report performed by the end-user and saves to the database 113, 114.

In step 203, the program 110 performs data extraction by identifying “key concepts” within the report content.

In step 204, the extracted “key concepts” (in unstructured form) are presented by the program 110 for review by the end-user (i.e., a visual display on the display 102 can be enhanced by color coding, for example).

In step 205, the program 110 receives editing of the report, if editing of the “key concepts” (by adding, deleting, or modifying the highlighted data) is desired by the end-user, and saves to the database 113, 114.

In step 206, the finalized “key concepts” unstructured data are automatically mapped by the program 110 to the context-specific ontology/lexicon and converted into structured (standardized) data in step 207.

In step 208, the end-user is presented with the extracted (unstructured) and derived (structured) data elements for review, by the program 110. The end-user may a) accept “as is” (see FIG. 2B, step 209), b) may reject and manually elect to edit the structured data—the editing data being saved by the program 110 in step 210, or c) elect to utilize the automated editing option by the program 110, which is saved in step 211.

The “finalized” report data is recorded in the database 113, 114, and corresponding data are transferred to a series of structured report databases 113, 114, in step 212.

Before completing report creation, the end-user is presented by the program 110 in step 213, with the option of identifying selected structured data elements for prospective analysis (see FIG. 3).

In step 214, the structured report output is customized in accordance with the pre-defined report presentation templates of the end-user, in addition to individual physicians accessing the report data. (Note that this customization feature can be done in real-time, since the core structured data remains constant and the presentation consists of the application of a presentation template.)

In step 215, the structured report presentation state of the end-user is presented for final verification to the end-user, by the program 110.

In the automated editing option (step 211 above), as shown in FIG. 3, the end-user first activates automated editing option function.

Thereafter, the program 110 queries a context and user-specific database 113, 114, in step 301, to search for “optimized” report parameters associated with the “key findings” identified in report.

In step 302, the program 110 identifies discrepancies between the end-user report and “optimized” report.

In step 303, the end-user is presented by the program 110 with the preliminary report data along with the “optimized” report data and is offered three (3) options:

a) accept the optimized report modifications in their entirety and save to the database 113, 114 (step 304).

b) edit the optimized report modifications and save thereafter to the database 113, 114 (step 305).

c) deny all optimized report modifications and accept preliminary report only, which is saved to the database 113, 114 in step 306.

If the edit optimized report modifications option is selected, the end-user reviews the presented modifications individually and selects/denies each modification on an individual basis. (This editing process can be done in a variety of ways including (but not limited to) speech commands, manual input (i.e., as described in copending U.S. patent application Ser. No. 11/806,596, filed Jun. 1, 2007, the contents of which are herein incorporated by reference in their entirety), or alternative input methodologies (i.e., as described in copending PCT Application No. 2009/005940, filed Nov. 3, 2009, the contents of which are herein incorporated by reference in their entirety).

In step 307, the program 110 presents statistical data in association with each recommended modification on the display 102, which the end-user can review or ignore.

If end-user elects to review the “statistical analysis” function, he/she is presented by the program 110 in step 308, with statistical data which summarizes the data associated with the recommended modification (e.g., 12% improvement in clinical outcomes).

Once the statistical review and editing functions have been completed, the end-user signs off the report in its final form, and the ‘final” report data is captured by the program 110 in the report databases 113, 114 in step 309, with unique tags applied to the individual end-user, institutional demographics, patient profile characteristics, context of the task being performed, and specific technology being utilized.

Based upon a cumulative analysis of “final” report data performed by the program in step 310, the individual report databases 113, 114 (e.g., end-user, technology-specific. institutional, context-specific) are continuously updated in step 311.

In FIG. 4, the prospective structured data analysis (step 213 in FIG. 2B) is activated by the end-user in step 400.

The specific structured data elements for analysis can be selected in the following manner:

a) the individual end-user manually selects the desired structured data elements (using similar input methodologies as previously described), and the program 110 accesses same in step 401.

b) the individual elects to utilize the “automated” analysis function of the program 110 in step 402, which determines the specific structured data analyses to be performed, based upon the individual end-user profile.

c) the individual elects to utilize the “global” analysis function of the program 110 in step 403, which determines the specific structured data analyses to be prospectively performed in accordance with computer-derived “best practice” guidelines.

In step 404, the end-user is periodically notified by the program 110 of the individual and collective analytical results based upon a pre-defined pathway:

a) emergent (results of high clinical significance) presented to end-user at the time of identification by the program 110.

b) non-emergent results (unique to the individual end-user)are presented by the program 110 to the end-user at his/her pre-defined schedule (e.g., weekly, monthly, quarterly).

c) collective results (from a pre-defined community of multiple users) are also presented by the program 110 on a pre-defined schedule.

Based upon any of these prospective analyses, the end-user can elect to incorporate the updates analyses into his/her “user and/or context specific default”, and the program 110 will save same to the database 113, 114 in step 405.

In step 406, in the future, whenever similar structured data is reported, these updated default parameters will be incorporated by the program 110 into the “automated analyses” function.

In an embodiment providing an education and training feature, the feature is activated (either manually by the end-user or automatically by the computer program 110).

Then, the specific structured data elements contained within the report data that are subject to the educational/training exercise, are highlighted by the program 110.

Thereafter, the structured report databases 113, 114 are automatically queried by the program 110 and data specific to that structured data element are presented to the end-user on the display 102.

The educational content can be grouped according to following categories:

a) EBM (best practice guidelines);

b) new research;

c) under-utilized functionality (i.e., tools available within the system that are not being routinely used by the individual end-user).

Once the selected educational feature is activated by the program 110, a computer-based educational module is opened by the program 110 and presented to the end-user with educational content specific to the structured data highlighted.

Thereafter, the user may utilize the educational module until finished, and then exit the module.

In a second embodiment consistent with the present invention, there is provided a data analysis and decision support feature for diagnosis and treatment options. Thus, in addition to the textual report data described above, many other types of medical data which could be accessed by the program 110 in data mining analysis, are stored within the EMR (i.e., a) clinical, b) molecular, c) laboratory, d) pathology, e) imaging, f) clinical testing, g) demographic, h) occupational/environmental, i) quality, and j) socio-cultural. The medical data may take the form of different presentation states, such as:

1) textual
a) patient/family members (i.e., past medical history, clinical symptoms)
b) medical documents (i.e., history and physical, discharge summary)
c) information system technologies (i.e., physician orders, list of medications)
d) clinical staff (e.g., nurses' notes, consultation report)

2) graphical
a) photographs (e.g., intra-operative, endoscopic)
b) medical imaging technologies (e.g., computed tomography, mammography)
c) clinical testing (e.g., electrocardiogram, electroencephalogram)
d) pathology (e.g., macro- and microscopic images)
e) trending analysis (e.g., chronologic display of weight or temperature)
f) symbols (e.g., Gesture-based reporting)

3) numerical
a) laboratory data (i.e., white blood cell count, sedimentation rate)
b) clinical testing (e.g., bone marrow biopsy, urinalysis)
c) molecular data (e.g., genetic markers, proteinomics)

A number of industry standards for graphical and numerical data ensure standardization (e.g., Digital Imaging and Communications in Medicine (DICOM) for medical imaging and the EC-11 standard from the Association for the Advancement of Medical Instrumentation for electrocardiogram data). This standardized data can then be pooled by the program 110 into a series of clinical databases 113, 114, which are stored at local, regional, and national levels for prospective analysis by the program 110.

Thus, the present invention is useful for differential diagnosis in a decision support application. In one embodiment of the decision support feature, specific data elements are inputted by the program 110 and differential medical diagnosis is elicited after analysis by the program 110, along with probability statistics.

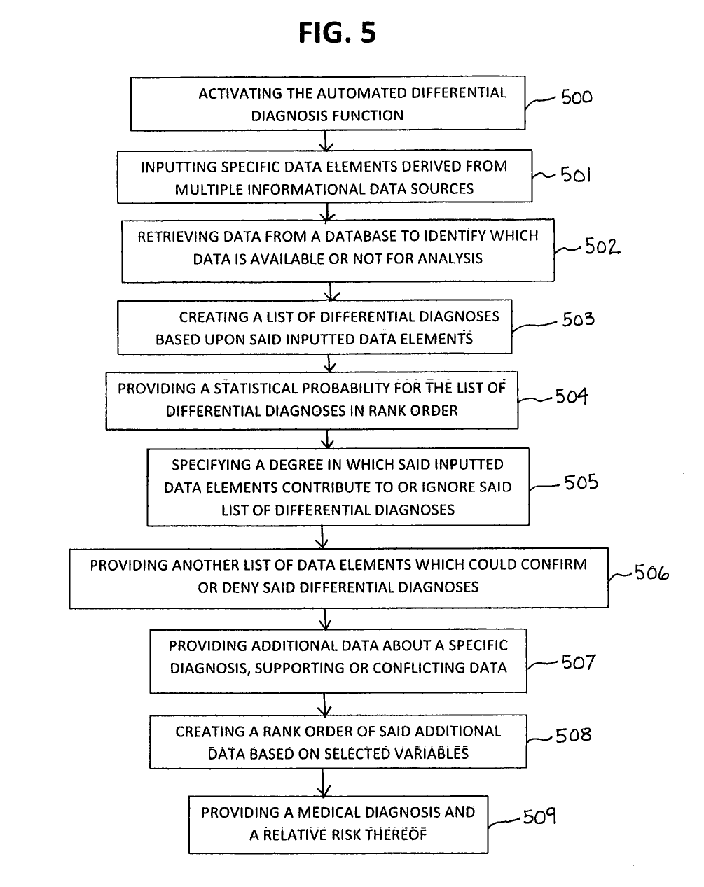

More specifically, in this embodiment (see FIG. 5), the end-user (e.g., clinician) seeks to make a diagnosis, based upon a series of disparate clinical data. He/she can activate the automated differential diagnosis function offered by the program 110 in step 500, and may input the specific data elements of interest in step 501. These data elements can be derived from multiple informational data sources (see above).

The program 110 would then in turn, retrieve data from the database 113, 114, to identify which data is available or not for analysis, in step 502. The program 110 will then create a list of differential diagnoses (using artificial intelligence techniques such as neural networks), based upon these inputted data and provide a statistical probability for each of the listed diagnoses in step 504.

The program 110 can highlight the degree in which the inputted data elements contributed to or contradicted the listed differential diagnosis in step 505. The program 110 would then list additional data elements which could confirm or deny the diagnosis in question in step 506, as well as alert the clinician to any missing data that would be helpful in the diagnosis.

To illustrate how this would work, an example of the following inputted data is received by the program 110, the data which is provided by a primary care physician who is seeing a new patient for the first time. Based upon the patient's past medical record and current symptoms, the following data is entered, with a program 110 query for differential diagnosis.

1) inputted Data:
a) symptoms:
i) progressive shortness of breath and chest pain, increased during stress.
b) signs:
i) tachycardia (pulse 112),
ii) tachypnea (respiratory rate 20),
iii) hypertension (162/98).
c) imaging:
i) chest radiograph: hyperinflation, bilateral interstitial change.
d) laboratory:
i) normal white blood cell count, low potassium.
e) historical:
i) no smoking history, employed as home maker.

2) computer generated differential diagnosis:
a) asthma (82% probability)
b) COPD (64% probability)
c) hypersensitivity pneumonitis (26% probability)
d) idiopathic interstitial pneumonitis (14% probability)

3) contradictory data
a) asthma—none
b) COPD—negative smoking history
c) hypersensitivity pneumonitis—normal WBC, no history of environmental exposure to allergin
d) idiopathic interstitial pneumonitis—hyperinflation

4) additional diagnostic data:
a) genetic markers: CD14
b) laboratory data: IgE
c) clinical tests: Spirometry (FEV1), Arterial blood gas (PaO2, PaCO2)
d) occupational data: environmental exposures, allergins, smoking history
e) imaging: High resolution chest CT

The clinician can then select any of the data provided by the program 110 in step 507, to learn more about the specific diagnosis offered, supporting or conflicting data, or additional data for consideration, including, for example, clinician diagnostic statistics. If, for example, he/she selects the clinical test spirometry, he/she would be provided by the program 110 with the specific tests which would be applicable, and shown how the data would differ between the four (4) presented differential diagnostic entities.

In addition, the program 110 can create a rank order of these “additional diagnostic data” based upon a series of selected variables such as cost, morbidity, and exclusionary diagnostic capabilities in step 508. By doing so, the clinician would be provided with a means to use the computer database 113, 114 to obtain a differential diagnosis in step 509, learn which data within the patient's medical record support and/or contradict each diagnosis, and identify additional clinical data for definitive diagnosis determination, with the relative cost, morbidity, and differentiating abilities of each recommended data element.

In another embodiment of the decision support feature of the present invention, patient-specific genetic data is inputted to determine the probability of disease occurrence (in conjunction with other data elements contained within the database 113, 114).

In this embodiment, the end-user could input a number of different data elements within the individual patient's medical record, into the database 113, 114, to determine the statistical probability of disease occurrence. The type of presentation states of the medical data would include: a) textual (1. patient/family members (i.e., past medical history, clinical symptoms), 2. medical documents (e.g. history and physical, discharge summary), 3. information system technologies (e.g., physician orders, list of medications), 4. clinical staff (e.g. nurses notes, consultation report)); b) graphical (1. photographs (e.g., intra-operative, endoscopic), 2. medical imaging technologies (e.g., computed tomography, mammography), 3. clinical testing (e.g. electrocardiogram, electroencephalogram), 4. pathology (e.g. macro and microscopic images), 5. trending analysis (e.g., chronologic display of weight or temperature), 6. symbols (e.g., Gesture-based reporting)); and c) numerical (1. laboratory data (i.e., white blood cell count, sedimentation rate), 2. clinical testing (i.e., bone marrow biopsy, urinalysis), 3. molecular data (i.e., genetic markers, proteinomics)).

As an example, a woman undergoes annual mammography exams for breast cancer detection. On the most recent mammogram, a small poorly defined density was reported within the left breast, which was not present on prior exams. The radiologist interpreting the mammogram offered two options for follow-up including immediate biopsy and short-term mammographic follow-up in six (6) months. When the patient presented to her gynecologist's office to discuss the exam results, she became extremely anxious and distraught. She inquired as to the probability of breast cancer and asked the gynecologist for an exact probability of the mammographic finding representing cancer, as well as the risk of waiting if she elected to have the six-month follow-up mammogram.

Using the decision support feature of the present invention, the gynecologist was able to derive statistical probabilities of disease occurrence, relative risk, and diagnostic options in the following manner:

The gynecologist enters, and the program 110 receives a request for computer-generated query of breast cancer risk (i.e., the automated differential diagnosis function is activated).

A computer-generated risk of breast cancer risk factors is provided by the program 110 to the physician, in hierarchical rank order according to statistical importance.

The program 110 also retrieves all relevant data from the patient s medical record and identifies which relevant data are currently available for analysis, as well as which data are not available for analysis.

Using the available data, the program 110 generates a probability statistic of breast cancer as well as diagnostic confidence, based upon available data.

In this specific example, the program 110 has identified the following available breast cancer risk factors within the patient medical record: a) race/ethnicity: African

American, b) medications: oral contraceptives, c) weight: overweight (30 pounds above ideal weight), and d) abnormal mammogram.

The computer alerts the physician as to data not contained within the patient medical record which would be important in accurately determining breast cancer: a) genetic markers for breast cancer: BRCA1, BRCA2, HER2, b) individual radiologist interpretation profile (i.e., relative risk of the finding being representative of breast cancer relative to his/her peer group), c) clinical breast exam, d) family history of breast cancer, and e) imaging: MRI.

After having the patient undergo genetic testing, the data which is saved in the database 113, 114, the physician learns that the genetic markers for breast cancer are all negative.

On physical exam, the physician finds no abnormality in the region of mammographic concern, which data is saved in the database 113, 114.

No first degree relative has documented breast cancer upon a search of the database 113, 114, by the program 110.

On statistical analysis of the imaging database 113, 114 by the program 110, it is determined that the radiologist interpreting the mammogram has a higher than normal incidence of false positive biopsy recommendations (i.e., suspicious mammogrpahic findings found to be benign on biopsy).

When factoring in these additional data, the program 110 derives a relative risk of breast cancer to be low and a conservative approach is elected, with six-month mammography follow-up.

In addition, upon query by the physician queries, the program 110 identifies a radiologist with high mammography interpretation statistics, and requests a second opinion from that radiologist.

In another embodiment of the decision support feature, the present invention can determine association relationships (and the statistical likelihood of association) between disparate data elements (e.g., imaging data and physical examination findings), specific to a medical diagnosis.

Specifically, in the course of determining the statistical likelihood of individual data elements being associated with, or contradictory to, a specific medical diagnosis, many different types of data are analyzed (see the above presentation of medical data elements in the second application). Often times, the combination of two different data elements become synergistic to one another, so that the presence of these two disparate data elements increases the statistical probability of diagnosis beyond what would be expected on an individual basis.

As an example, a patient with hyperinflation on chest radiography (imaging data) who also is a longstanding smoker (historical clinical data), would have a much higher statistical probability of the diagnosis COPD, based upon the combination of these two data. Longitudinal mining of the database 113, 114 by the program 110 (in conjunction with clinical outcomes data), provides a mechanism to determine these association relationships between disparate data elements, as they relate to specific medical diagnoses and treatment outcomes.

In yet another embodiment of the decision support feature, a clinician may input a specific medical diagnosis and the program 110 can be queried to provide supporting and contradictory data (with computer-generated probability statistics).

This embodiment represents the reverse of the first embodiment of the decision support feature, where individual data elements were entered and the program 110 was queried in order to provide a differential diagnosis. In this example, an individual medical diagnosis is inputted, and the program 110 is asked to determine which data elements are consistent with and contradictory to the diagnosis in question.

In this embodiment of the decision support feature, a data element is inputted (i.e., medical diagnosis, physical exam finding, symptom), and a list of tests is derived by the program 110 to facilitate the diagnostic work-up, which includes the following data: a) probability of definitive diagnosis, b) cost-efficacy, c) probability of adverse action (i.e., introgenic complication).

As described in the previously cited example, a number of automated decision support features can be derived from the present invention, which can be initiated by an electronic query by the program 110, of the end-user. Note that each query can be recorded by the program 110 into a database 113, 114, which can in turn be used for analysis by the program 110, in order to create a user-specific decision support profile.

This user-specific decision support profile could subsequently determine the specific types of queries and functions different end-users perform, and in turn create automatic prompts by the program 110, which can be delivered in real-time at the point of care.

In addition, this user-specific profile can also be used to identify specific education/training programs tailored to each individual end-users' needs. As an example, if a hospital administrator repeatedly uses the decision support tools to determine relative cost efficiency of different treatment regimens, the program 110 may provide that administrator with updated guides of routine pharmaceutical and procedural costs, as well as comparative costs of different service and drug suppliers in the local area.

If a clinician frequently seeks out best clinical practice guidelines for certain types of medical conditions, then the program 110 can automatically send him/her updates evidence-based medicine (EBM) guidelines each time new releases take place within the medical literature.

While the input options for automated decision support are essentially unlimited, a number of general examples can illustrate how the present invention would work. For this example, the steps an individual end-user might take in the diagnostic work-up of an unknown medical condition; along with some of the associated analytical tools available to determine potential complication rates and cost-efficiency, are provided.

In this example, a new patient presents to a physician's office complaining of intermittent chest pain of increasing severity.

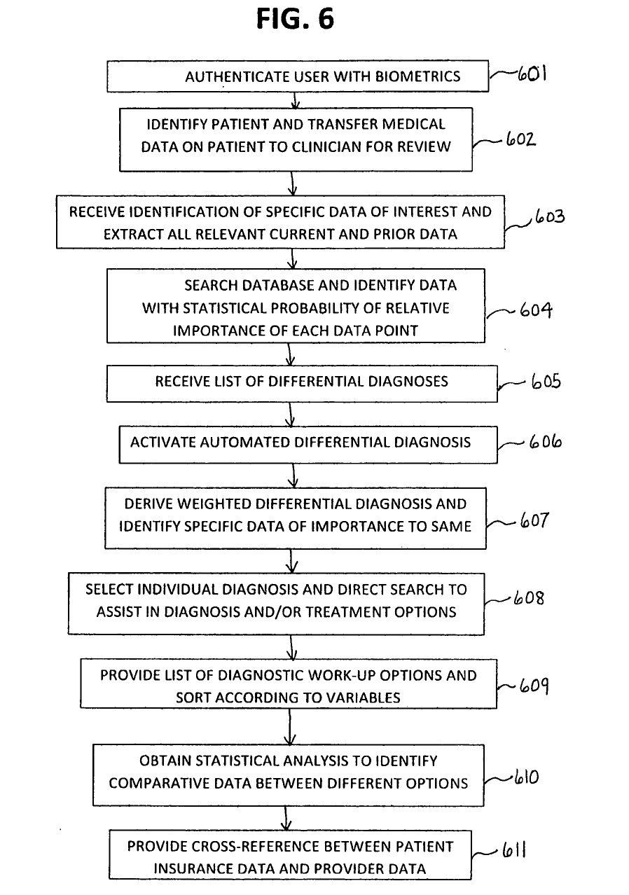

The physician performs a history and physical on the patient, and enters this information into the electronic medical record (EMR) (see FIG. 6).

In step 601, both the physician and patient are authenticated into the medical database using biometrics (see U.S. Pat. No. 7,593,549, issued Sep. 22, 2009, the contents of which are herein incorporated by reference in its entirety).

In step 602, the patient is identified by the program 110 within the database 114 (from another medical facility), and past medical data are automatically transferred to the physician for review, by the program 110.

In step 603, the physician identifies the specific data of interest (e.g., worsening chest pain) and requests the program 110 to extract all relevant current and prior data.

In step 604, the program 110 searches its database 113, 114 and identifies relevant data, with a statistical probability of relative importance attached to each data point, and provides it on the display 102.

Once the data review has been completed by the physician, the physician enters a list of differential diagnoses (e.g., atypical angina) into the database 113, 114, in step 605.

The physician then requests an automated differential diagnosis to be performed by the program in step 606.

In step 607, the program 110 (using artificial intelligence) then derives its own weighted differential diagnoses, and identifies the specific data which was of greatest importance in contributing to each individual diagnosis.

The physician can select any individual diagnosis and then direct a targeted query by the program 110 to assist in diagnosis and/or treatment planning options in step 608. In this example, the physician selects the diagnosis of atypical angina and requests options.

In step 609, the program 110 provides a list of diagnostic work-up options which can be sorted according to a number of different variables (i.e., timeliness, cost, morbidity).

The physician can then obtain a statistical analysis by the program 110 in step 610, where the program 110 identifies comparative data between different options. As an example, if the physician selects the option of “timeliness” he/she would be provided with “cardiac catheterization” by the program 110, as the timeliest clinical test offering diagnosis. If the physician then requested the “morbidity” data option, he/she would be presented by the program 110 with complication rates associated with cardiac catheterization.

If the physician wanted to obtain more detailed data of cardiac catheterization complication rates, he/she can query the program 110 to present comparative complication rates in a defined geographic area. The program 110 would then present the physician with comparative complication rates of different institutions within the defined geographic region, along with individual cardiac surgeons performing that specific procedure.

The physician could also request a cross-reference by the program 110 in step 611, of the patient's insurance data with this provider data to determine which provider with the lowest complication rates, are covered in the patient's insurance plan. The physician can then present the data-driven diagnostic options to the patient.

The patient could then inquire as to the comparative coverage of different insurance plans for the top three surgeons of record from the program 110 and the specific “out of pocket” expenses which would be incurred for the procedure of record. This information could then be used by the patient in determining which insurance carrier to select and the relative costs for different coverage options.

In yet another embodiment of the decision support feature, a medical diagnosis may be inputted and the program 110 can generate recommendations for disease prevention, diagnosis, and/or treatment in accordance with the patient and provider specific data, as described above.

In yet another embodiment of the decision support feature, disease-specific data is inputted into the database 113, 114, and the database 113, 114 can be searched by the program 110 for patients with similar data elements and defined diagnoses.

The ability to cross reference data from numerous databases (i.e., meta-analysis) is an important feature of the program 110 of the present invention and provides large sample size statistics. An end-user can not only generate a query specific to a given patient, but also query the database 113, 114 for the program 110 to narrow the analysis to patients with similar data.

As an example, if a physician wants to determine medical treatment options for a patient with newly diagnosed hypertension, he/she could define the search by selecting the specific data points of interest for the program 110. In addition to the degree of hypertension, the physician may also want to define the search conducted by the program 110, by patient physical characteristics (e.g., height, weight, body mass index), drug allergies, and other medical conditions (e.g., diabetes, congestive heart failure).

The program 110 could then search the database 113, 114 to identify which patients fit a similar profile and cross reference this patient-specific data with comparative treatment options and clinical outcomes. This data can then be used by the physician in selecting the optimal drug of choice in initiating treatment for hypertension. If the physician wants to go one step further and determine cost-efficacy, he/she could utilize the program 110 to determine which drugs are available in generic form and what the differential costs would be for the first and second drugs of choice under the patient's insurance plan.

In yet another embodiment of the decision support feature, a medical diagnosis is inputted into the database 113, 114 and the program 110 can query the database 113, 114 for associated data elements related to the diagnosis in question.

As described above, an end-user could input (or select) a specific diagnosis and have the program 110 search the database 113, 114 to locate what specific data points are consistent with, and which data points contradict, the diagnosis in question. In addition to characterizing these data, the program 110 could also provide weighted values as to the relative strength of the association. This provides an excellent educational tool for the user, to facilitate an understanding of the various factors contributing to disease, as well as the relative importance of individual variables, along with the potential synergy of multiple variables.

In yet another embodiment of the decision support feature, and as described above, the diagnosis is inputted into the database 113, 114, and the program 110 can search the database 113, 114 for specific tests and procedures for confirmation.

In yet another embodiment of the decision support feature, and as described above, tests and/or procedures are inputted into the database 113, 114, for the program 110 to derive the statistical likelihood of iatrogenic complications or adverse reactions relative to the statistical likelihood of success (i.e., computer-generated risk/benefit analysis specific).

In yet another embodiment of the decision support feature, and as described above, test/procedures are inputted so that the program 110 can derive the statistical likelihood of adverse action specific to the clinical provider, host institution, and/or technology being used.

In yet another embodiment of the decision support feature, and as described above, the diagnosis and procedural data are inputted into the database 113, 114 for the program 110 to determine the clinical outcomes statistics specific to: a) treatment region, b) clinical provider, c) patient genetic disposition, d) pathology data, e) technology utilized.

One important feature of the present invention is the ability to perform clinical outcomes analysis using the structured data contained within the database 113. 114, factoring in a number of confounding variables. Using this clinical outcomes analysis, best practice (EBM) guidelines can in turn be derived by the program 110, to improve practice performance measures. Since each patient, provider, and institution have their own unique variables associated with them, it is important that the program 110 factor these into the overall analysis. Examples of these stakeholder-specific variables may include the patient's genetic predisposition to certain disease states (molecular data), institutional demographics, the technology being utilized for diagnosis and/or treatment, pathology sub-type, and individual provider's clinical performance record.

To illustrate how these variables impact clinical outcomes analysis, an example of a patient with newly diagnosed lung cancer is used. In the course of the diagnostic work-up, the patient underwent a chest CT scan for diagnosis and staging, surgical biopsy of the cancer for pathologic diagnosis, and molecular analysis for determination of patient genetic predisposition. The patient presents to the medical oncologist to determine treatment options and prognostication.

Using the available data contained within the patients' medical record (and cross-referencing this within the multi-institutional database 113, 114 using the program 110). the program 110 can derive the following information for the oncologist:
a) morbidity and mortality statistics associated with the specific diagnosis (e.g., small cell lung cancer), clinical stage (size and extent of tumor), pathology grade (i.e., microscopic aggressiveness), and molecular composition.
b) medical treatment options and tumor responsiveness in accordance with the aforementioned tumor characteristics.
c) treatment responsiveness in accordance with the individual patient's medical status (e.g., co-morbidity, drug resistance).
d) treatment options available (e.g., surgical excision, chemotherapy, radiation therapy).
e) comparative analysis of institutional and individual providers (e.g., institutions and individual clinical providers with the best treatment statistics for this specific tumor type/subtype).
f) specific responsiveness of available chemotherapeutic agents, based upon the genetic make-up of both the patient and tumor.
g) for radiation therapy, comparative analysis of technology used for radiation therapy.

Using this multivariate analysis, the oncologist can determine the optimal treatment options for the patient, in accordance with multi-institutional data analysis and established EBM standards.

In yet another embodiment of the decision support feature, as discussed above, the program 110 can perform a cross-correlation of data to derive disease-specific best practice guidelines (for prevention, diagnosis, treatment).

In yet another embodiment of the decision support feature of the present invention, and as described above, the program 110 can create technology and provider-specific clinical outcomes statistics, which can be derived from specific diagnoses and patient profiles (i.e., patient-specific demographic, genetic, and clinical data): e.g., breast cancer: a) best provider for screening mammogram (screening), b) best provider for breast biopsy (diagnosis), c) best surgeon for surgical excision (treatment), and d) best radiation/medical oncologist (treatment).

In yet another embodiment of the decision support feature of the present invention, the program 110 can utilize multi-institutional database 113, 114 to create patient, institutional, and technology-specific profiles—i.e., low/intermediate/high risk patient profiles in accordance with multiple variables: a) demographic data (age, gender. weight, economic status), b) clinical data (PMI-1, other diagnoses, ongoing treatment/medications), c) compliance (clinical accountability, adherence to prescribed therapy, reliability in appointments), and d) genetic data (disease predisposition, responsiveness to therapy, associated risk factors).

The multi-institutional data available for analysis by the program 110 provides a mechanism to create data-driven profiles of patients, providers, institutions, and technologies. These profiles can be used by the program 110 to provide a ranking system to more reliably predict clinical outcomes, improve decision-making, and facilitate economic incentives for improved levels of healthcare delivery.

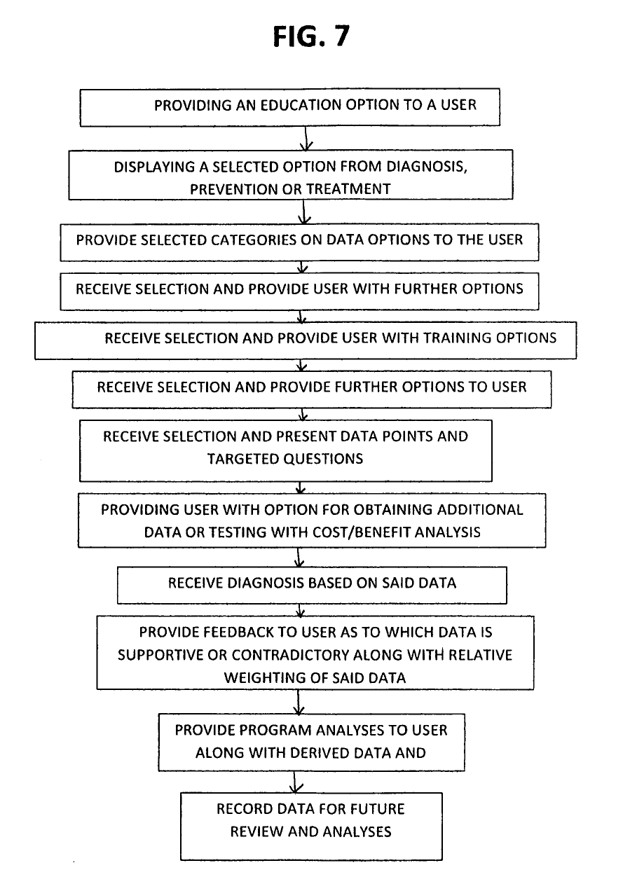

The present invention has an education and training feature, which is described as follows (see FIG. 7).

The education & training feature is activated (either manually by the end-user, or automatically by the program 110.

The specific structured data elements contained within the report data that are subject to the educational/training exercise are highlighted by the program 110 on the display 102.

The structured report databases 113, 114 are automatically queried by the program 110 and data specific to that structured data element are presented on the display 102 by the program 110, to the end-user.

The educational content determined by the program 110, can be grouped according to following categories: a) EBM (best practice guidelines), h) new research, and c) under-utilized functionality (i.e., tools available within the system 100 that are not being routinely used by the individual end-user).

Once the selected educational feature is activated, a computer-based educational module is opened by the program 110 and the program 110 presents the end-user with educational content specific to the structured data highlighted on the display 102.

The education and training features of the invention are important and provide a data-driven means to improve performance. An example of these educational properties can be illustrated in the following example.

In step 700, a medical student selects the education option of the invention, and the program 110 opens this feature.

In step 701, the medical student selects from the following options a) diagnosis. b) prevention, c) treatment), and then selects the Diagnosis option, which the program 110 displays.

In step 702, the program 110 then provides the user with the following options: a) clinical data, b) laboratory data, c) imaging data, d) testing data, e) genetic data, and f) combination.

In step 703, the student selects the Combination option and is then presented by the program 110 with a list of disease options to choose from: a) cardiovascular, b) musculoskeletal, c) neurologic, d) trauma, e) respiratory, f) gastrointestinal, g) lymphoproliferative, h) genitourinary, i) endocrinoloic, j) infectious disease, and k) other. The student either selects the desired category of disease or inputs a specific disease diagnosis, for the program 110 to retrieve. In this case, the student selects Cardiovascular.

In step 704, the program 110 then presents the student with a list of training options: a) case study, b) diagnostic review, and c) statistical analysis.

In step 705, the student selects Case study and is then presented by the program 110 with an unknown patient within the cardiovascular disease category.

In step 706, the program 110 presents the student with a sequence of data points and targeted questions, in which the student is graded for accuracy.

In step 707, the program 110 provides the student with the option of obtaining additional data specific to each question or continuing in sequence.

At any point in the exercise the student can present a diagnosis, based upon the data previously received.

The student can also request additional tests for assistance, with the relative cost-benefit analysis of each test/procedure presented to the student by the program 110 and factored into their analysis.

In step 708, when a diagnosis is rendered by the student, the program 110 in step 709, provides feedback as to which data are supportive and/or contradictory, along with the relative weighting (i.e., clinical importance) of these data.

At the end of the exercise, in step 710, the student is presented by the program 110 with a number of analyses, which may include the following: a) accuracy in computer-derived questions (specific to the diagnosis being assessed), b) ability to render a correct diagnosis, c) timeliness in rendering a diagnosis, d) cost-efficacy of diagnosis, and e) problem solving capabilities. The derived data can be presented to the student by the program 110, along with comparative data of their peers.

In step 711, this data is then recorded by the program 110 into the individual medical student's database 113, 114 for future review and analysis.

Thus, the present invention provides a new methodology for the conversion of unstructured, free text data into standardized, structured data, and a decision support option which provides the user with a medical diagnosis, as well as an educational feature.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A computer-implemented method of identifying and extracting predetermined conceptual information from a free text report, comprising:
extracting data elements from the free text report;
performing a statistical analysis of said data elements to identify the predetermined conceptual information and locate synonymous nomenclature;
mapping said synonymous nomenclature to a standardized lexicon such that a single set of structured data elements is recorded as report data in a report in a report database; and
performing clinical validation of said nomenclature mapping step to verify said standardized lexicon.

2. The method according to claim 1, wherein said data elements include at least technical data, historical data, clinical data, and imaging data.

3. The method according to claim 2, further comprising:
performing outcomes analysis of said report data.

4. The method according to claim 3, further comprising:
establishing a profile for a clinician that defines context-specific data requirements for said clinician.

5. The method according to claim 5, further comprising:
performing trending analysis to provide statistical data outlining performance metrics and best practice guidelines.

6. The method according to claim 2, further comprising:
automatically editing said report.

7. The method according to claim 2, further comprising:
performing prospective structured data analysis of said report.

8. The method according to claim 2, further comprising:
providing data specific to said structured data elements; and
presenting educational content specific to said structured data elements.

9. A computer-implemented method of providing data analysis and decision support in a medical application, comprising:
activating an automated differential diagnosis function;
inputting specific data elements derived from multiple informational data sources;
creating a list of differential diagnoses based upon said inputted data elements;
providing a statistical probability for each said list of differential diagnoses in rank order;
specifying a degree in which said inputted data elements contribute to or ignore said list of differential diagnoses;
providing another list of data elements which could confirm or deny said differential diagnoses; and
determining a medical diagnosis and a relative risk thereof.

10. The method according to claim 9, further comprising:
providing information on a specific diagnosis, and supporting or conflicting data thereon.

11. The method according to claim 10, further comprising:
inputting patient-specific genetic data to determine a probability of disease occurrence.

12. The method according to claim 9, further comprising:
retrieving data from a database to identify which data is available for analysis and which data is not available for analysis, after said inputting step.

13. The method according to claim 9, further comprising:
determining association relationships between disparate data elements specific to said medical diagnosis.

14. A computer-implemented method of providing data analysis and decision support in a medical application, comprising:
activating an automated differential diagnosis function;
inputting a specific medical diagnosis;
determining specific data elements derived from multiple informational data sources related to said medical diagnosis;
specifying a degree in which said data elements contribute to or ignore said medical diagnosis; and
determining whether said data elements confirm or deny said medical diagnosis.

15. The method according to claim 9, wherein an analysis of said database is used to create a user-specific decision support profile for at least an education/training program.

16. A computer-implemented method of providing data analysis and decision support in a medical application, comprising:
providing medical data on a patient from a database;
identifying specific data of said medical data related to the patient and retrieving current and prior data from said database;
providing a statistical probability of relative importance of each specific data;
receiving a list of differential diagnoses;
performing an automated differential diagnosis function;
deriving a weighted differential diagnosis; and
providing specific data which contributed to said weighted differential diagnosis.

17. The method according to claim 16, further comprising:
selecting an individual diagnosis and providing diagnosis and/or treatment planning options.

18. The method according to claim 16, further comprising:
obtaining a statistical analysis to identify comparative data between different diagnoses and/or treatment planning options.

19. The method according to claim 18, further comprising:
providing comparative complication rates in a defined geographic area.

20. The method according to claim 16, further comprising:
cross-referencing insurance data of said patient with provider data to determine a provider with a lowest complication rate.

21. The method according to claim 16, further comprising:
generating recommendations for disease prevention, diagnosis and/or treatment in accordance with patient and provider specific data.

22. The method according to claim 16, further comprising:
providing disease-specific data into said database and locating patients with similar data elements and defined diagnoses.

23. The method according to claim 16, further comprising:
inputting tests and/or procedures into said database to derive a statistical likelihood of iatrogenic complications or adverse reactions.

24. The method according to claim 16, further comprising:
inputting diagnosis and procedural data into said database to determine clinical outcomes.

25. The method according to claim 16, further comprising:
performing a cross-correlation of data to derive disease-specific best practice guidelines.

26. The method according to claim 16, further comprising:
creating technology and provider-specific clinical outcomes statistics from specific diagnoses and patient profiles.

27. The method according to claim 16, further comprising:
utilizing multi-institutional databases to create patient, institutional, and technology-specific profiles.

28. The method according to claim 16, further comprising:
marking specific structured data elements contained within report data;
providing data specific to said structured data elements; and
providing educational content specific to said highlighted structured data elements.

29. A computer-implemented method of providing an education and training feature in a medical application, comprising:
activating an education option for a user;
displaying a selected option from one of diagnosis, prevention or treatment;
providing the user with a training option;
providing the user with an option for obtaining additional data, or testing with a cost/benefit analysis thereof;
providing feedback to the user as to which data is supportive or which data is contradictory along with relative weighting of said data; and
providing analyses to the user along with derived data and comparative data of peers.

30. The method according to claim 29, further comprising:
recording said data for future review and analyses.
